(19) United States
(12) Patent Application Publication
(10) Pub. No.: US 2017/0210053 A1
(43) Pub. Date: Jul. 27, 2017

(54) COMPOSITE STRUCTURES WITH STIFFENERS AND METHOD OF MAKING THE SAME

(71) Applicant: THE BOEING COMPANY, Chicago, IL (US)

(72) Inventors: Max Marley Osborne, Melbourne (AU); David Andrew Pook, Melbourne (AU); Andrew Kenneth Glynn, Seattle, WA (US); Lauren Anne Burns, Melbourne (AU); Ronnie Karol Ligeti, Port Melbourne (AU); Peter J. Lockett, Melbourne (AU); James A. Thomas, Wildwood, MO (US)

(21) Appl. No.: 15/008,162

(22) Filed: Jan. 27, 2016

(51) Int. Cl. B29C 53/04; B29C 65/02

(52) U.S. Cl. CPC B29C 53/04; B29C 65/02; B29L 2031/3076

(57) ABSTRACT

A method for assembling a stiffened composite structure includes a step of co-bonding a cured infused composite stiffener to a pre-preg composite laminate skin element, wherein the pre-preg composite laminate skin element is dimensionally changeable. Another method for assembling a stiffened composite structure includes a step of coupling a cured infused composite stiffener which includes a preform of a plurality of braided fibers to a pre-preg composite laminate skin element, wherein the pre-preg composite laminate skin element is dimensionally changeable.

### FIELD

This disclosure generally relates to composite structures, and more particularly to composite structures that include stiffener members and methods for making the same.

### BACKGROUND

It is sometimes necessary to reinforce composite structures, such as those used in aerospace industry in order to meet needed strength and/or stiffness requirements. These structures include, for example, a skin of an aircraft such as that of a wing and/or fuselage. Skin structures are lightweight and are often thin gauged panels which need added strength and stiffness. Other structures in the aerospace industry, as well as, structures in other industries also need additional strength and/or stiffness. Adding stiffeners to a composite structure, such as to a skin structure of an aircraft, provides the needed strength and rigidity for demands placed on the skin structure of the aircraft.

Traditionally in constructing a reinforced skin, one that comprises a skin and a stiffener or a stringer structure, various fabrication processes have been employed to construct the reinforced skins. In one fabrication process, laying up composite pre-preg material for both the skin and the stiffener structures has been used. Alternatively, fabrication processes have used infusion processes wherein dry fiber was infused with resin for the stiffener elements and dry fibers were homogeneously infused with resin for the skin panel elements.

Utilizing pre-preg was advantageous for purposes of constructing the skin element since composite pre-preg material promoted tight control of optimized fiber volumes for structural efficiency and provided the opportunity to utilize automated lamination equipment to reduce labor costs. The stiffener or stringer structure, on the other hand, required non-automated and expensive hand labor lamination processes. The stiffener often required complex geometries in configuring the stiffener or stringer structure element. Stringers demanded careful placement onto the skin element to avoid fiber waviness in the stiffener structure. Fiber waviness could otherwise reduce performance of the stiffener. Additional complications arose in the fabrication of the stiffener and skin elements both being fabricated by a pre-preg layup process. Use of traditional pre-preg material in this fabrication required high temperature and high pressure curing processes which could introduce undesired results in the finished product. These high temperature and high pressure cure requirements for pre-preg material have been in the more recent past been somewhat ameliorated with utilizing pre-preg material which cures at lower temperatures and lower pressures.

Other past methods for assembling a reinforced skin structure would include making both the skin and the stiffener or stringer structures, as mentioned above, being homogenously constructed from an infused fiber fabrication process with curing the two structures at the same time. The skin structure and the stiffener structure have different fiber configurations and arrangements. The different fiber configurations and arrangements introduce different demands on the infiltrating resin during the infusion process for both of these structures. These demands provide further complications for a homogeneous co-infusion process of both the skin and stiffener structures.

Other processes for fabricating, for example a wind turbine blade, includes an outer structure constructed of dry fibers being infused with resin and an inner structure being constructed of a layup pre-preg structure positioned within the outer structure. Both of these structures are thereafter co-cured. In this process unidirectional pre-preg material is positioned within or otherwise enveloped within a fiber fabric system. The fiber fabric system and the enveloped pre-preg material are then positioned within the confinement of a vacuum bag. Infusion of resin is performed on the fiber fabric system which surrounds the pre-preg element. The infused assembly is co-cured. In this process the pre-preg material forms a connection with the infused fiber bed which surrounds the pre-preg material.

In other fabrication processes, a pre-cured stiffener is fabricated separate and apart from a pre-cured pre-preg skin which has been fabricated with a laying-up process. The pre-cured stiffener structure and the pre-cured skin structure are joined with secondary bonding. The pre-cured stiffener and pre-cured skin structures need to be independently fabricated with geometrical precision to have the surfaces of each of these pre-cured structures properly complement one another and achieve the needed geometries of the assembled structure and to promote a secure secondary bonding together of the two structures together.

### SUMMARY

An example of a method for assembling a stiffened composite structure includes a step of co-bonding a cured infused composite stiffener to a pre-preg composite laminate skin element wherein the pre-preg composite laminate skin element is dimensionally changeable.

Another example of a method for assembling a stiffened composite structure includes a step of coupling a cured infused composite stiffener which includes a preform of a plurality of braided fibers, wherein the pre-preg composite laminate skin element is dimensionally changeable.

### BRIEF SUMMARY OF THE DRAWINGS

FIG. 1 is a perspective view of an aircraft;

FIG. 2 is a partial broken away perspective view of pre-preg composite laminate fuselage skin element of the aircraft of FIG. 1 with infused composite stiffener elements coupled to a pre-preg composite laminate fuselage skin element;

FIG. 3 is a flow chart for a first embodiment of a method for assembling a stiffened composite structure including coupling a pre-cured infused composite stiffener element to a pre-preg composite laminate skin element and co-bonding these elements together;

FIG. 4 is a schematic exploded cross section view taken along line 4-4 of FIG. 2 of a first example of the stiffened composite structure assembled by the method for assembling the stiffened composite structure of FIG. 3; and

FIG. 5 is a schematic exploded cross section view taken along line 4-4 of FIG. 2 of a second example of the stiffened composite structure assembled by the method for assembling the stiffened composite structure of FIG. 3.

### DESCRIPTION

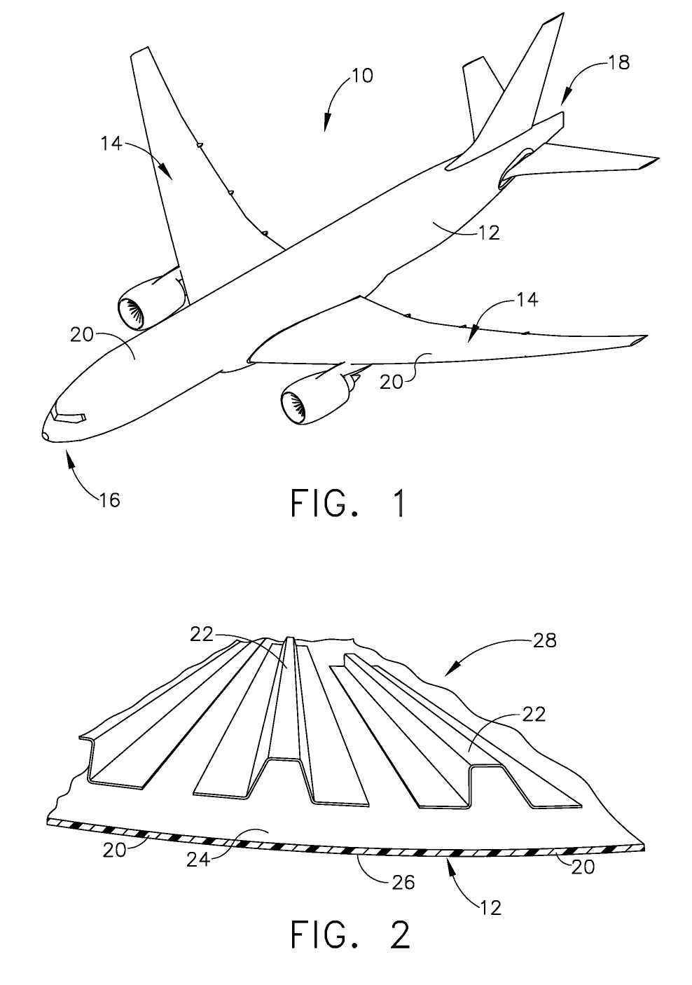

Referring to FIGS. 1 and 2, aircraft 10 includes structures of fuselage 12, wings 14, nose section 16 and tail section 18. Currently many of these structures of aircraft 10 are now constructed with composite materials. Composite materials provide beneficial properties to the structure of aircraft 10 with being lightweight and also providing strength. External portions of aircraft 10, such as, skin element or structure 20 of wings 14 and fuselage 12 are constructed of composite material having a generally panel shaped construction which is subjected to aerodynamic forces with aircraft 10 in operation. Additional strength to skin element or structure 20 is provided to resist these operational forces with the addition of coupling stiffeners 22, such as stringers, to skin structure 20.

In referring to FIG. 2, pre-preg composite laminate skin element or structure 20, in this example, is a portion of the construction of fuselage 12. Stiffeners or stringers 22 are positioned on an internal surface 24 of composite skin structure 20 in order to provide additional strength to skin structure 20 and at the same time not interfere with the aerodynamics of external surface 26 of skin structure 20 of aircraft 10. Stiffeners 22, to effectively provide the needed reinforcement to skin structure 20, need to closely follow curvatures of skin element or structure 20 and other complex geometries presented by skin structure 20 in the construction of such structures of fuselage 12 and wings 14 of aircraft 10. As will be described herein, stiffeners 22 will be constructed with use of infusion of resin into a plurality of braided dry fibers.

It will be appreciated that automated equipment can be employed for assembling stiffened composite structure 28 which includes pre-preg composite laminate skin element or structure 20 and stiffener 22. Automation will provide labor cost savings for laying-up plies, for example, of pre-preg composite laminate skin structure 20 and for fabricating braided plurality of dry fibers into preforms, for example, for infused stiffeners 22. Automation of plurality of braided dry fiber preforms will provide the needed precision in assembling stiffener 22 such that the preform of the plurality of dry fibers will conform to complex curvatures and geometries of skin element or structure 20, as well as to other structures to be reinforced, and will avoid unwanted wrinkling configurations of the fibers within the composite material of stiffener 22 which could otherwise affect strength performance of stiffener 22.

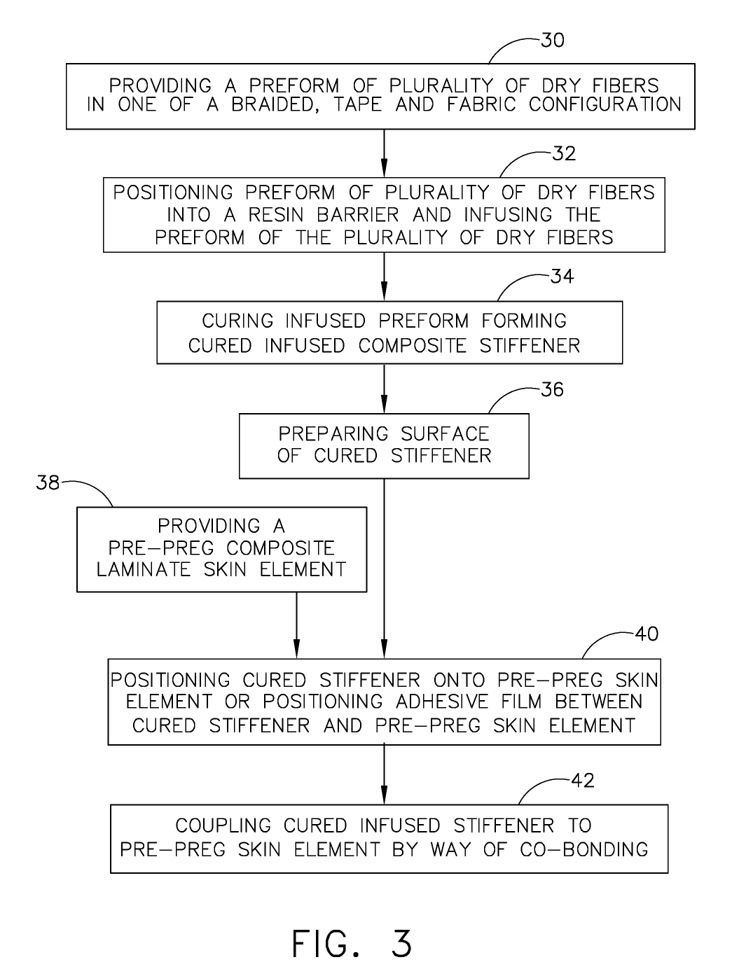

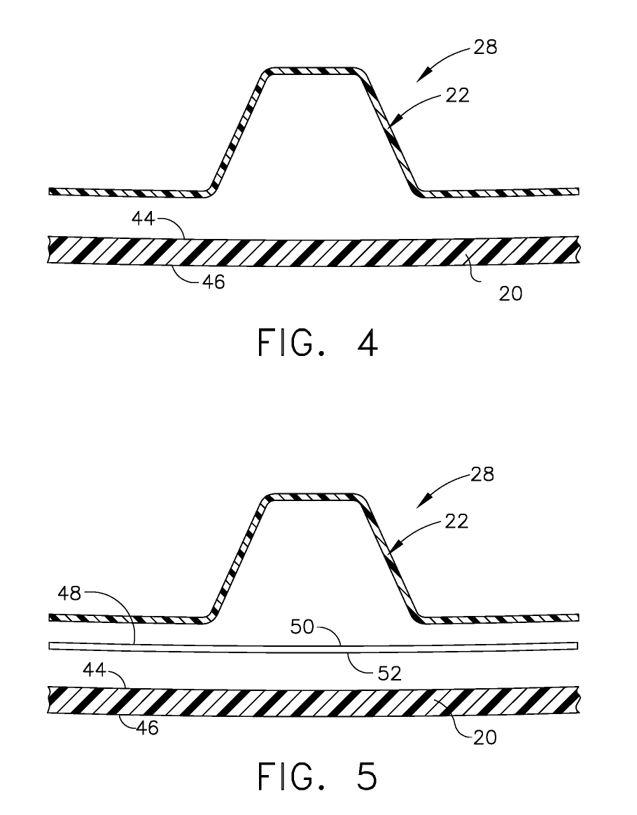

A method for assembling stiffened composite structure 28, as seen in FIG. 2, includes steps as set forth in FIG. 3 and described herein below. As will be appreciated, cured stiffener 22 and pre-preg composite laminate skin structure 20 are separately prepared assemblies that are brought together and co-bonded. Step 38 includes providing a pre-preg composite laminate skin element or structure 20 wherein the pre-preg composite laminate skin element or structure 20 is dimensionally changeable. The resin in the pre-preg composite material has not yet advanced in a curing process such that dimensions of the skin element or structure 20 can be changed dimensionally. In this embodiment, pre-preg composite laminate skin element 20 is in Stage B with respect to curing. The method for assembling stiffened composite structure 28 further includes steps 30, 32 and 34 which set forth steps for assembling cured infused composite stiffener 22, as will be discussed in more detail below. Step 36 includes preparing a surface of cured infused composite stiffener 22 for a co-bonding process with pre-preg composite laminate skin element 20. Step 40 further includes positioning composite stiffener 22 onto pre-preg composite laminate skin element 20, as seen in FIG. 4, or positioning an adhesive film 48, as seen in FIG. 5, between cured infused composite stiffener 22 and pre-preg composite laminate skin element 20. Once step 40 has been carried out, step 42 of coupling the cured infused composite stiffener 22 to the pre-preg composite laminate skin element 20 is accomplished with co-bonding. These steps will be discussed in further detail below.

Step 38 of providing pre-preg composite laminate skin element or structure 20 further includes a step of laying up a plurality of pre-preg composite plies. As mentioned above, this step of laying up a plurality of pre-preg composite plies can be a fully automated process. Plies of composite material include fibers that are constructed of a material selected from a wide variety of materials such as glass, aramid or carbon. Similarly, the plies are constructed of a resin selected from a wide variety of resins such as epoxy or bismaleimide resins which may also include toughening additives or components such as thermoplastics or silicon or other particles. The laminate can be assembled with a number of plies that are needed for the construction of a particular composite element or structure and the fiber orientation for the each ply can be positioned as needed for the construction of a particular composite element or structure as well. In this embodiment, pre-preg composite laminate skin element or structure 20, as mentioned above, is at a Stage B of curing, permitting structure 20 to be in a state or condition wherein the dimensions of structure 20 are changeable.

The method for assembling stiffened composite structure 28, as seen in the flow chart of FIG. 3, sets forth the fabricating of infused cured composite stiffener 22 separate and apart from the pre-preg laminate skin element or structure 20. Fabricating infused composite stiffener 22 includes step 30 of providing a plurality of dry fibers, in this example, in a preform in one of braided, tape and fabric configuration. Step 30 of providing the plurality of dry fibers, in this example, is being used for fabricating aircraft 10 which includes having complex geometries in aircraft 10 structure. The plurality of dry fibers are configured to accommodate the complex geometries so as to properly provide the needed strength for a particular component of aircraft 10 being fabricated. As mentioned above, automated equipment can be employed in configuring the fibers and to properly and precisely follow the complex geometries. The plurality of dry fibers may take on a wide range of configurations such as into a preform having a configuration, for example, of at least one of a radius of less than one hundred and sixty inches (160 inches) about a first axis (not shown) and a degree of twist of less than two degrees per inch (2° per inch) about a second axis (not shown).

In step 30, in this example, the composition of the plurality of dry fibers are selected from fibers constructed of one of carbon, aramid and glass. In this example, carbon fibers are employed. The dry carbon fibers are positioned in one of a configuration of braided, tape and fabric utilizing automated equipment and in this example the carbon fibers are braided. The automated equipment, with use of mandrels, if needed, provides accurate construction of the preform so as to provide manufacturing efficiency and precision. Precision is needed to construct a preform that will accommodate the complex geometries and curvatures stiffener 22 in order to address the proper strength support to skin element or structure 20 in fabricating the stiffened composite structure 28. The reliability of implementing use of automated braiding equipment and mandrels promotes dimensional accuracy of stiffener 22 and reduces the occurrence of unwanted fiber waviness.

In this example, the braided preform of plurality of dry fibers is positioned on a tool that accurately replicates the size and shape needed for stiffener 22 to operate with skin element 20. Step 32 of positioning the preform of plurality of dry fibers within a resin barrier and infusing the preform is conducted for fabricating the infused composite stiffener 22. The resin barrier, for example, includes a consumable such as a vacuum bagging film. A vacuum is applied, in this example, to the interior of the bagging film and an epoxy based resin, such as Hexcel RTM6, manufactured by Hexcel Corp. of Dallas, Tex., is drawn into the resin barrier or bagging film infusing the preformed braided, in this example, plurality of dry fibers forming an infused composite stiffener 22. The epoxy based resin is infused, in this example, at a temperature of approximately two hundred and fifty degrees Fahrenheit (250° F.).

The method for assembling composite stiffened structure 28 further includes step 34 of curing infused composite stiffener 22 separate from pre-preg composite laminate skin element 20 and prior to coupling infused composite stiffener 22 to pre-preg composite laminate skin element 20. The curing of stiffener 22 will include, in this example, heating infused stiffener 22 to a temperature up to approximately three hundred and fifty degrees Fahrenheit (350° F.). The pressure applied stiffener 22 in this curing process includes approximately one half an atmosphere of pressure for lower pressure infusion processes up to multiple atmospheres of pressure for higher pressure injection molding processes. The cured infused composite stiffener 22, in this example, results in mass fraction of resin of approximately thirty to thirty five percent (30% to 35%) and a fiber volume fraction of approximately fifty five to sixty percent (55% to 60%).

Once infused stiffener 22 has been cured, in this example, step 36 of preparing surface of cured stiffener 22 takes place. In preparation of co-bonding stiffener 22 and skin 20, in this example, a surface of stiffener 22 is either abraded to form a roughened surface on stiffener 22 or a layer of material of stiffener 22 is removed. The prepared surface of stiffener 22 facilitates coupling stiffener 22 and skin 20, in this example, with co-bonding of stiffener 22 to skin element 20.

As described above, pre-preg composite laminate skin element 20 and infused cured composite stiffener 22 are constructed separately from one another. Once pre-preg composite laminate skin element 20 has been assembled, step 38 of providing the pre-preg composite laminate skin element 20 is taken so as to be able to proceed with the step of coupling skin element 20 and infused composite stiffener 22 together.

An example of a composite stiffener structure 28 is shown in FIG. 4 in an exploded schematic view which has been fabricated from this method. In preparation for step 42 of coupling infused composite stiffener 22 to pre-preg composite laminate skin element 20 by co-bonding step 40 of positioning cured infused composite stiffener 22 onto skin element 20 is taken. As shown in FIG. 4, skin element 20 includes first side 44 and opposing second side 46 wherein cured infused stiffener 22 is positioned onto first side 44 of skin element 20. During the co-bonding process of stiffener 22 and skin element 20, the resin of pre-preg composite laminate skin element 20 facilitates co-bonding stiffener 22 to skin element 20.

In a second example of this method, an exploded schematic view of a composite stiffener structure 28 is shown in FIG. 5 fabricated from the method. In this example, step 40 is employs positioning an adhesive film 48 between and in contact with cured infused composite stiffener 22 and first side 44 of pre-preg composite laminate skin element 20. Adhesive film 48 provides two opposing sides 50 and 52. In this example, adhesive film 48 includes Metlbond 1515, manufactured by Cytec Industries. In the co-bonding process of stiffener 22 and skin element 20, side 50 of adhesive film 48 secures or bonds to cured stiffener 22 and side 52 of adhesive film 48 secures or bonds to first side 44 of pre-preg composite laminate skin element 20. Adhesive film 48 provides in addition to securing surfaces of sides 50 and 52 adhesive film 48 but also serves to provide a robust mechanical bond between the two elements, that may contain two different resin systems which may or may not otherwise provide a chemical bond.

The method for assembling stiffened composite structure 28 further includes step 42, as seen in FIG. 3, of co-bonding together a cured infused composite stiffener 22 to the pre-preg composite laminate skin element 20. With stiffener 22 positioned onto skin element 20, in one example, or adhesive film 48 is positioned between and in contact with cured infused stiffener 22 and pre-preg composite laminate skin element 20, in another example, the co-bonding step 42 is employed.

In this example, low temperature and low pressure curing pre-preg is used for pre-preg composite laminate skin element 20 in the method for assembling stiffened composite structure 28. This low temperature and low pressure pre-preg material is often referred to as out of autoclave pre-preg. Step 42 of co-bonding the cured infused composite stiffener 22 to the pre-preg composite laminate skin element 20 includes a step of applying heat to the cured infused composite stiffener 22 and the pre-preg composite laminate skin element 20 to a temperature within a temperature range which includes two hundred and ten degrees Fahrenheit (210° F.) up to and including two hundred and eighty degrees Fahrenheit (280° F.). This relatively lower temperature range for co-bonding of stiffener 22 to pre-preg skin element 20 reduces the introduction of additional defects in the fabrication of composite stiffened structure 28 which otherwise can be introduced with use of higher temperatures. The step of co-bonding cured infused composite stiffener 22 to pre-preg composite laminate skin element 20 includes a step of applying pressure to the cured infused composite stiffener 22 and pre-preg composite laminate skin element 20 which includes a pressure within a pressure range which includes atmospheric pressure up to and including forty five pounds per square inch (45 psi) of pressure.

While various embodiments have been described above, this disclosure is not intended to be limited thereto. Variations can be made to the disclosed embodiments that are still within the scope of the appended claims.

What is claimed:

1. A method for assembling a stiffened composite structure, comprising:
co-bonding a cured infused composite stiffener to a pre-preg composite laminate skin element, wherein the pre-preg composite laminate skin element is dimensionally changeable.

2. The method for assembling of claim 1, further includes a step of positioning a plurality of dry fibers into a configuration having a radius of less than one hundred and sixty inches (160 inches) about a first axis for assembling the cured infused composite stiffener.

3. The method for assembling of claim 1, further includes a step of positioning a plurality of dry fibers into a configuration having a degree of twist of the plurality of dry fibers about a second axis of less than two degrees per inch (2° per inch) for assembling the cured infused composite stiffener.

4. The method for assembling of claim 1, further includes a step of positioning a plurality of dry fibers in one of a braided, tape and fabric configuration within a resin barrier and infusing the plurality of dry fibers with a resin material forming an infused composite stiffener.

5. The method for assembling of claim 4 further includes a step of curing the infused composite stiffener.

6. The method for assembling of claim 5, wherein the pre-preg composite laminate skin element comprises a first side and an opposing second side, further including a step of positioning the cured infused composite stiffener onto the first side of the pre-preg composite laminate skin element.

7. The method for assembling of claim 6, wherein the step of co-bonding the cured infused composite stiffener to the pre-preg composite laminate skin element includes a step of applying heat to the cured infused composite stiffener and the pre-preg composite laminate skin element to a temperature within a temperature range which includes two hundred and ten degrees Fahrenheit (210° F.) to and including two hundred and eighty degrees Fahrenheit (280° F.).

8. The method for assembling of claim 6, wherein the step of co-bonding the cured infused composite stiffener to the pre-preg composite laminate skin element includes a step of applying pressure to the cured infused composite stiffener and the pre-preg composite laminate skin element to a pressure within a pressure range which includes atmospheric pressure up to a pressure which includes forty five pounds per square inch (45 psi).

9. A method for assembling a stiffened composite structure, comprising:
coupling a cured infused composite stiffener comprising a preform of a plurality of braided fibers to a pre-preg composite laminate skin element wherein the pre-preg composite laminate skin element is dimensionally changeable.

10. The method for assembling of claim 9, further includes a step of positioning a plurality of dry fibers into a configuration having a radius of less than one hundred and sixty inches (160 inches) about a first axis for assembling the cured infused composite stiffener.

11. The method for assembling of claim 9, further includes a step of positioning a plurality of dry fibers into a configuration having a degree of twist of the plurality of dry fibers about a second axis of less than two degrees per inch (2° per inch) for assembling the cured infused composite stiffener.

12. The method for assembling of claim 9, further includes a step of positioning a plurality of dry fibers within a resin barrier and infusing the plurality of dry fibers with a resin material forming an infused composite stiffener.

13. The method for assembling of claim 12 further includes a step for curing the infused composite stiffener.

14. The method for assembling of claim 13, wherein the pre-preg composite laminate skin element comprises a first side and an opposing second side, further including a step of positioning the cured infused composite stiffener onto the first side of the pre-preg composite laminate skin element.

15. The method for assembling of claim 14, wherein the step of coupling comprises co-bonding the cured infused composite stiffener to the pre-preg composite laminate skin element which further includes a step of applying heat to the cured infused composite stiffener and the pre-preg composite laminate skin element to a temperature within a temperature range which includes two hundred and ten degrees Fahrenheit (210° F.) to and including two hundred and eighty degrees Fahrenheit (280° F.).

16. The method for assembling of claim 14, wherein the step of coupling comprises co-bonding the cured infused composite stiffener to the pre-preg composite laminate skin element and further includes a step of applying pressure to the cured infused composite stiffener and the pre-preg composite laminate skin element to a pressure within a pressure range which includes atmospheric pressure up to a pressure which includes forty five pounds per square inch (45 psi).

17. The method for assembling of claim 13, wherein the pre-preg composite laminate skin element comprises a first side and an opposing second side, further including a step of positioning an adhesive film between and in contact with the cured infused composite stiffener and the first side of the pre-preg composite laminate skin element.

18. The method for assembling of claim 17, wherein the step of coupling comprises co-bonding the cured infused composite stiffener to the pre-preg composite laminate skin element which includes a step of applying heat to the cured infused composite stiffener and the pre-preg composite laminate skin element to a temperature within a temperature range which includes two hundred and ten degrees Fahrenheit (210° F.) to and including two hundred and eighty degrees Fahrenheit (280° F.).

19. The method for assembling of claim 17, wherein the step of coupling comprises co-bonding the cured infused composite stiffener to the pre-preg composite laminate skin element which includes a step of applying pressure to the cured infused composite stiffener and the pre-preg composite laminate skin element to a pressure within a pressure range which includes atmospheric pressure up to a pressure which includes forty five pounds per square inch (45 psi).
